(19) United States
(12) Patent Application Publication
(10) Pub. No.: US 2001/0034660 A1
(43) Pub. Date: Oct. 25, 2001

(54) Goods and services referring by location

(76) Inventor: Heinz Heumann, Brussels (BE)

Correspondence Address: Jay Sandvos, Bromberg & Sunstein, 125 Summer Street, Boston, MA, 02110-1618, US

(21) Appl. No.: 09/780,141

(22) Filed: Feb. 9, 2001

Related U.S. Application Data
(60) Provisional application No. 60/181,348, filed on Feb. 9, 2000.

(51) Int. Cl. G06F 17/60

(52) U.S. Cl. 705/26

(57) ABSTRACT

A method and computer program for communicating business information to a user are described. A request from a user is processed for the identity of at least one product provider, which is: (i) located within a selected distance of a user location, and (ii) identified as providing a user-specified product. Based on the request, information is retrieved from a product provider database information associated with the product provider. The information includes the location of the at least one product provider. The retrieved information is then communicated to the user.

### FIELD OF THE INVENTION

The invention generally relates to business methods, and more particularly, to providing goods and services to mobile users based on their geographic location.

### BACKGROUND ART

In the world of commerce, stores and businesses seem to be changing at ever faster rates. New businesses spring up, and old businesses shut down or are renamed. And, within a given commercial establishment, the goods and services are changing just as rapidly, changing names, changing products, changing sizes and prices. Moreover, as individuals are ever more mobile, we frequently find ourselves in new and different places. All of this makes it more and more difficult for a consumer to know where to go to obtain specific desired goods and services.

### BRIEF DESCRIPTION OF THE DRAWINGS

The present invention will be more readily understood by reference to the following detailed description taken with the accompanying drawings, in which:

FIG. 1 illustrates the basic concept of typical embodiments of the present invention.

FIG. 2 illustrates the logical sequence of steps in a typical embodiment.

### DETAILED DESCRIPTION OF SPECIFIC EMBODIMENTS

As used in this description and the following claims, the term “products” refers to both goods and services available in the stream of commerce.

Various embodiments of the present invention are directed to an interactive search process between a mobile client user and a central server regarding products available to the user, based on the user's location. The user communicates with the server using a Mobile Communication Terminal (MCT) via a wireless communications link.

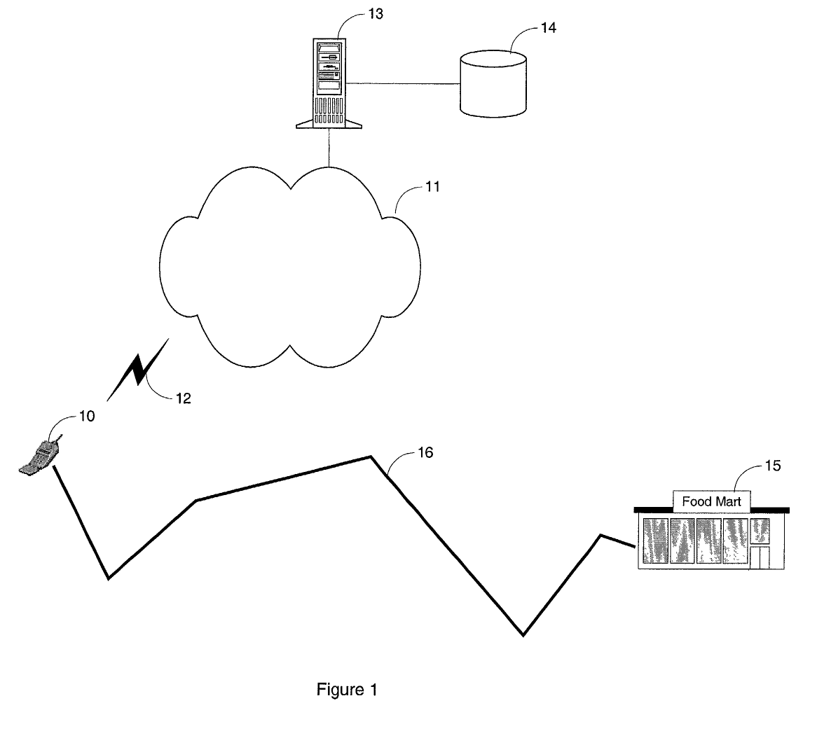

FIG. 1 shows the basic concept of a typical embodiment. A mobile communications terminal (MCT) 10 is in communication with a computer network 11 via a wireless communications link 12. Examples of such an MCT 10 include, without limitation, a mobile or cellular telephone, a personal digital assistant (PDA) type device or a handheld navigational system with mobile communications capability, and various hybrid combinations of these. An MCT may also incorporate sophisticated user interaction technology such as intelligent agents (IA), automatic speech recognition (ASR), text-to-speech (TTS), natural language processing (NLP), automatic translation from one language to another, etc.

Also in communication with the network 11 is a server 13 having access to a product provider database 14 containing data base records for various product providers, such as food mart 15 in FIG. 1. The database records include information such as listings of products and prices, and also, for each product provider, a geographic location. In further embodiments, the database 14 also may include a specific location within the product provider for some or all of the products.

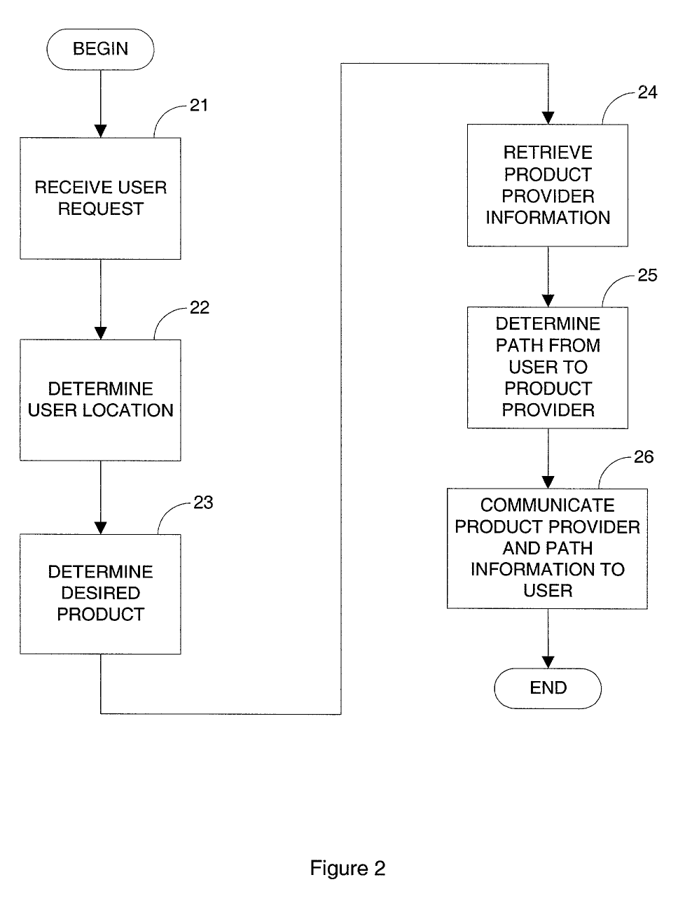

FIG. 2 shows the logical sequence of steps in a typical embodiment. The MCT 10 sends a request message from a user, via the wireless communications link 12 and the network 11, which is received by the server 13, step 21. The request message contains a query from a user regarding where to purchase a specific product. For example: “Where is the nearest store that sells Acme ice cream?” Depending on the specific embodiment, the request message itself may be formed from input text, touch screen input, or spoken text input.

The request message may also contain information regarding the location of the user. This location information may be manually entered by the user when composing the request message, in which case the location may be either the user's present location or an anticipated future location. Or, the location information may be automatically determined by a process within the MCT 10. For example, the MCT 10 may include a global positioning system process (GPS) that determines the location of the MCT from a satellite system. Other approaches are known for determining the location of a device, including without limitation radio systems (e.g., LORAN), cellular triangulation systems, inertial navigation systems, etc. In alternative embodiments, the user location information may not be included in the request message or determined by the MCT 10. For example, an independent external locator system may determine the location of the MCT 10, such as by a radio triangulation system, by IFF-type querying of the MCT, or a hybrid dead reckoning system that periodically confirms the MCT location.

In any event, upon receiving the user request, the server 13 determines the location of the user, step 22. From the request message, the server 13 also determines the desired product, step 23. Determining the desired product from the request message may be relatively straightforward if the MCT 10 provides the request in predefined format. In more sophisticated embodiments, however, either the MCT 10 or the server 13, or both, may linguistically process the request to extract the desired product information. Examples of such linguistic processing include automatic speech recognition (ASR) of a spoken input, natural language processing (NLP), automatic translation from one language to another, etc.

Based on the user location and desired product information extracted from the request message, the server 13 then accesses the product provider database 14 and retrieves information regarding the desired product, step 24, for providers within a selected geographic threshold of the user location. The geographic threshold may be selected by the user, or in the absence of user selection, it may be a default value such as ¼ mile.

Depending on system defaults and user-selectable options, the information retrieved in step 24 may be no more than the name of the product provider nearest to the user's location, which has the desired product. Where multiple product providers carry the desired product, of course the server 13 must compare the location of the provider to the user's location to determine which product provider is nearest.

In step 24, additional information also may be retrieved by the server 13 from the product provider database 14. For example, the price of the desired product may be retrieved for communication to the user. Price and provider location may also be used to rank multiple product providers. For example, all product providers within a selected distance of the user's location may be ranked by distance from the user. Thus, the three nearest product providers may be determined, or all product providers within one half mile may be determined. Multiple product providers also may be ranked in order of price from lowest to highest.

In a typical embodiment, the server 13 also determines a navigational path 16 from the user's location to at least one of the product providers satisfying the request criteria, step 25. The path 16 may be determined as a route on a map or as turn-by-turn type instructions in text, graphical, or audio form. In an alternative embodiment, the path 16 may be determined in step 25 by the MCT 10 rather than the server 13. For example, the MCT 10 may include a DVD- or CD-ROM-based storage system containing navigational data sufficient for the MCT to calculate the navigational path 16.

In step 26, product provider and navigational path information are communicated back from the server 13, via the network 11 and the wireless communication link 12, to the user at the MCT 10. The path information is communicated to the user via the MCT 10 in one of the path information forms described in the preceding paragraph. Other information also may be communicated to the user in step 26, such as the name of the product provider, the price of the product, the location of the product within the store, any promotional special offers, etc. Based on this communicated information, the user is now empowered to act as an efficient and knowledgeable consumer.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of communicating business information to a user, the method comprising:
processing a request from a user for the identity of at least one product provider, which is:
(i) located within a selected distance of a user location, and
(ii) identified as providing a user-specified product;
retrieving from a product provider database information associated with the least one product provider, the information including the location of the at least one product provider; and
communicating the retrieved information to the user.

2. A method according to claim 1, further comprising:
determining a path from the user location to the location of the at least one product provider, and communicating the path to the user.

3. A method according to claim 2, wherein communicating the path to the user includes providing a graphical representation of the path.

4. A method according to claim 2, wherein communicating the path to the user includes providing audio instructions.

5. A method according to claim 2, wherein communicating the path to the user includes providing text instructions.

6. A method according to claim 1, wherein processing the request includes performing automatic speech recognition of a spoken request from the user to produce a representative text request.

7. A method according to claim 1, wherein processing the request includes performing automatic translation of the request from a first language to a second language.

8. A method according to claim 1, wherein the user location is specified by the user in the request.

9. A method according to claim 1, wherein the user location is provided by a satellite positioning process.

10. A method according to claim 1, wherein the user location is provided by a cellular positioning process.

11. A method according to claim 1, wherein the user location is provided by a dead reckoning process.

12. A method according to claim 1, wherein information associated with each of at least two product providers is retrieved and communicated.

13. A method according to claim 12, wherein communicating the retrieved information to the user includes ranking the at least two product providers according to a user-specified ranking criterion.

14. A method according to claim 13, wherein the user-specified ranking criterion is cost of the product.

15. A method according to claim 13, wherein the user-specified ranking criterion is distance from the user location to each of the at least two product providers.

16. A method according to claim 1, wherein the information includes price of the user-specified product.

17. A method according to claim 1, wherein the selected distance is userspecified.

18. A computer program for communicating business information to a user, the program comprising:
request processing logic for processing a request from a user for the identity of at least one product provider, which is:
(i) located within a selected distance of a user location, and
(ii) identified as providing a user-specified product;
information retrieving logic for retrieving from a product provider database information associated with the least one product provider, the information including the location of the at least one product provider; and
user communicating logic for communicating the retrieved information to the user.

19. A computer program according to claim 18, further comprising:
path determining logic for determining a path from the user location to the location of the at least one product provider, and communicating the path to the user.

20. A computer program according to claim 19, wherein the user communicating logic includes logic for providing a graphical representation of the path.

21. A computer program according to claim 19, wherein the user communicating logic includes logic for providing audio instructions.

22. A computer program according to claim 19, wherein the user communicating logic includes logic for providing text instructions.

23. A computer program according to claim 18, wherein the request processing logic includes logic for performing automatic speech recognition of a spoken request from the user to produce a representative text request.

24. A computer program according to claim 18, wherein the request processing logic includes logic for performing automatic translation of the request from a first language to a second language.

25. A computer program according to claim 18, wherein the user location is specified by the user in the request.

26. A computer program according to claim 18, wherein the user location is provided by a satellite positioning process.

27. A computer program according to claim 18, wherein the user location is provided by a cellular positioning process.

28. A computer program according to claim 18, wherein the user location is provided by a dead reckoning process.

29. A computer program according to claim 18, wherein information associated with each of at least two product providers is retrieved and communicated.

30. A computer program according to claim 29, wherein the user communicating logic includes logic for ranking the at least two product providers according to a user-specified ranking criterion.

31. A computer program according to claim 30, wherein the user-specified ranking criterion is cost of the product.

32. A computer program according to claim 30, wherein the user-specified ranking criterion is distance from the user location to each of the at least two product providers.

33. A computer program according to claim 18, wherein the information includes price of the user-specified product.

34. A computer program according to claim 18, wherein the selected distance is user-specified.
